(19) United States
(12) Patent Application Publication
(10) Pub. No.: US 2023/0179060 A1
(43) Pub. Date: Jun. 8, 2023

(54) COOLING SYSTEM FOR ELECTRIC SYSTEMS

(71) Applicants: Abishek SRIDHAR, Windsor (CA); Ram BALACHANDAR, Windsor (CA); Ronald Michael BARRON, Windsor (CA); Lakshmi Varaha IYER, Troy, MI (US); Gerd SCHLAGER, St. Valentin (AT); Martin WINTER, Dietach (AT)

(72) Inventors: Abishek SRIDHAR, Windsor (CA); Ram BALACHANDAR, Windsor (CA); Ronald Michael BARRON, Windsor (CA); Lakshmi Varaha IYER, Troy, MI (US); Gerd SCHLAGER, St. Valentin (AT); Martin WINTER, Dietach (AT)

(21) Appl. No.: 17/925,950

(22) PCT Filed: May 18, 2021
(86) PCT No.: PCT/US2021/032860

§ 371 Date: Nov. 17, 2022

Related U.S. Application Data
(60) Provisional application No. 63/026,472, filed on May 18, 2020.
(60) Provisional application No. 63/051,119, filed on Jul. 13, 2020.

(51) Int. Cl. H02K 5/20; H02K 9/197; H02K 3/24

(52) U.S. Cl. CPC H02K 5/203; H02K 9/197; H02K 3/24

(57) ABSTRACT

A cooling jacket for an electric motor comprises a fluid passage disposed adjacent to a stator and configured to convey a cooling fluid. The cooling jacket includes a flow mixing enhancer within the fluid passage adjacent an axial end of the stator. The flow mixing enhancer includes baffles, a porous fibrous structure, and/or an open-cell foam to provide greater thermal conductance at a region adjacent to the axial ends than it provides to a central region therebetween. A flow bridge directs the cooling fluid through circumferential flow paths adjacent to both of the axial ends before the cooling fluid is circulated in a central flow path around the central region of the stator. One or more nozzles direct a jet of cooling fluid upon the stator end winding, a rotor end winding, and/or printed circuit board. A ring-shaped coolant header may supply the cooling fluid to the nozzles.

### CROSS-REFERENCE TO RELATED APPLICATIONS

This PCT International Patent application claims the benefit of and priority to U.S. Provisional Patent Application Ser. No. 63/026,472 filed on May 18, 2020, titled “Enhanced Liquid Jacket Cooling For Electric Motors,” and U.S. Provisional Patent Application Ser. No. 63/051,119 filed on Jul. 13, 2020, titled “Direct Liquid Cooling System For Electric Motors,” the entire disclosures of which are hereby incorporated by reference.

### FIELD

The present disclosure relates generally to systems for cooling electric motors. More specifically, the present disclosure relates to cooling stators and/or rotors of electric motors, such as traction motors in electrified vehicles, using a cooling jacket and/or one or more impinging jets of fluid.

### BACKGROUND

The market share of hybrid or fully electric automobiles has been on the rise over the past decade due to global efforts to reduce CO2 emissions, promote sustainable energy consumption, improve air quality, etc. Several countries have also implemented policies to phase-out the use of fossil-fuel vehicles within the next 5-30 years. These underlying objectives for the transition from traditional gasoline or diesel powered motors to electric motors are truly achievable only by increasing the efficiency of the electric motors. During various stages of the drive cycle, several parts in current electric motors, including stator/rotor windings and laminations, typically generate a combined 2-20 kW or more heat. Efficient thermal management for removal of this heat, and accurate temperature control of sub-components of the motor underpin the overall efficiency of the machine. Heat generation rates in different parts of the motor can vary substantially during the various stages of the drive cycle depending on the type of motors employed, such as AC synchronous motors. Besides optimal mechanical efficiency, ensuring that the motor windings are maintained within safe operating temperatures is also critical for increasing the life and reliability of the electric motors and for reducing maintenance costs for such electric motors.

The complexity in efficient cooling of electric motors lies in the fact that the heat generation around the motor is asymmetric and heterogeneous, with significant heat generation and substantially larger overall heat loss around the stator, rotor, and active windings. Traditional helical cooling channels around stator jackets are sub-optimal and result in substantially greater component temperatures and pressure drop. This also in turn detrimentally affects packaging design, material costs, etc. Furthermore, conventional cooling systems employing stator jackets alone imply that all the heat that is generated in the rotor components are also removed through the jacket. This invariably results in undesirably higher temperatures in the rotor. Ultimately, poor thermal management design leads to oversizing of the inverter, over-utilization of coolant and or cooling system components, and/or damage to the motor's electrical hardware, and thus de-rates the performance of the motor. This necessitates the development of improved thermal management and packaging designs. Most conventional stator jacket based cooling systems are bulky, while the reduction of cost and volume of such AC motor cooling systems can aid in the overall reduction of the weight of the electric vehicle. A 10% reduction in vehicle weight could yield up to 6% more driving range depending on the drive cycle and vehicle type.

### SUMMARY

In accordance with an aspect of the disclosure, an electric motor comprises a stator having a stator core and extending between a first axial end and a second axial end. The electric motor also comprises a cooling jacket disposed circumferentially around the stator core and configured to convey a cooling fluid therethrough. The cooling jacket has a first thermal conductance for transferring heat from the stator to the cooling fluid at a region between the first axial end and the second axial end. The cooling jacket also has a second thermal conductance at a region adjacent to at least one of the first axial end or the second axial end of the stator. The second thermal conductance is greater than the first thermal conductance.

### BRIEF DESCRIPTION OF THE DRAWINGS

Further details, features and advantages of designs of the invention result from the following description of embodiment examples in reference to the associated drawings.

FIG. 1A shows a perspective cutaway view of an electric motor, in accordance with the present disclosure;

FIG. 1B shows another perspective cutaway view of the electric motor of FIG. 1A;

FIG. 1C shows a sectional view of the electric motor of FIG. 1A;

FIG. 2 shows a sectional view of a stator of an electric motor;

FIG. 3 shows an enlarged section of an electric motor;

FIG. 4 shows a perspective view of a cooling jacket for an electric motor, with partial transparency, in accordance with the present disclosure;

FIG. 5 shows a perspective view of passages within the cooling jacket of FIG. 4;

FIG. 6 shows an unrolled view of a first flow mixing enhancer for a cooling jacket in accordance with aspects of the present disclosure;

FIG. 7 shows an unrolled view of a second flow mixing enhancer for a cooling jacket in accordance with aspects of the present disclosure;

FIG. 8 shows an unrolled view of a third flow mixing enhancer for a cooling jacket in accordance with aspects of the present disclosure;

FIG. 9 shows an unrolled view of a fourth flow mixing enhancer for a cooling jacket in accordance with aspects of the present disclosure;

FIG. 10 shows a cross-sectional view of an electric motor having a first configuration in accordance with an aspect the present disclosure;

FIG. 11 shows a cross-sectional view of an electric motor having a second configuration in accordance with an aspect the present disclosure;

FIG. 12 shows a cross-sectional view of an electric motor having a third configuration in accordance with an aspect the present disclosure; and

FIG. 13 shows a graph including plots of internal jacket temperatures for a conventional cooling jacket and for a cooling jacket in accordance with the present disclosure.

### DETAILED DESCRIPTION

Referring to the Figures, wherein like numerals indicate corresponding parts throughout the several views, a cooling jacket 40 for an electric motor 10 is disclosed. The cooling jacket 40 of the present disclosure particularly addresses and abates issues that can result from sub-optimal cooling in electric motors by incorporating novel passive heat transfer enhancement units into the motor stator jacket and modification of the coolant flow pathways.

Direct cooling of the rotor windings and associated internals can aid in significantly reducing the overall operating temperatures and improve efficiency and life of the motor. The present disclosure particularly addresses and abates these concerns of electric motor thermal management by the introduction of direct liquid impingement cooling on the stator and rotor end windings—the components that produce the greatest fraction of the overall heat generated in the motor, and with or without auxiliary cooling using a stator jacket with a size reduced by about 30% or more (covering the stator core lamination). In typical stator jacket cooling systems, the coolant loops or channels therein adjacent to the end windings are typically ineffective due to the high thermal resistance for direct transfer of heat from the windings to the jacket. This also applies to most machines that may or may not have thermally conductive epoxies around the windings. This results in most of the heat to flow through the stator laminations to the liquid cooled jacket—resulting in about 30% or more of the jacket in typical motors contributing the only a marginal fraction of the total heat removed. In various different configurations of this disclosure, this 30% or more of the jacket may be reduced to about the size of the stator laminations alone; further details are given below.

Optimization of the thermal management system for electric motors resulting in the reduction of component temperatures can aid in maximizing the power density, reliability, and efficiency. Thus, the thermal management system of the present disclosure can be beneficial to various on-road and under development motors for electric and hybrid electric vehicles. This novel technology can be directly applied to any electric motor regardless of the rotor type. For example, the disclosed thermal management system may be used with induction motors, wound field synchronous motors, permanent magnet synchronous motors, etc.

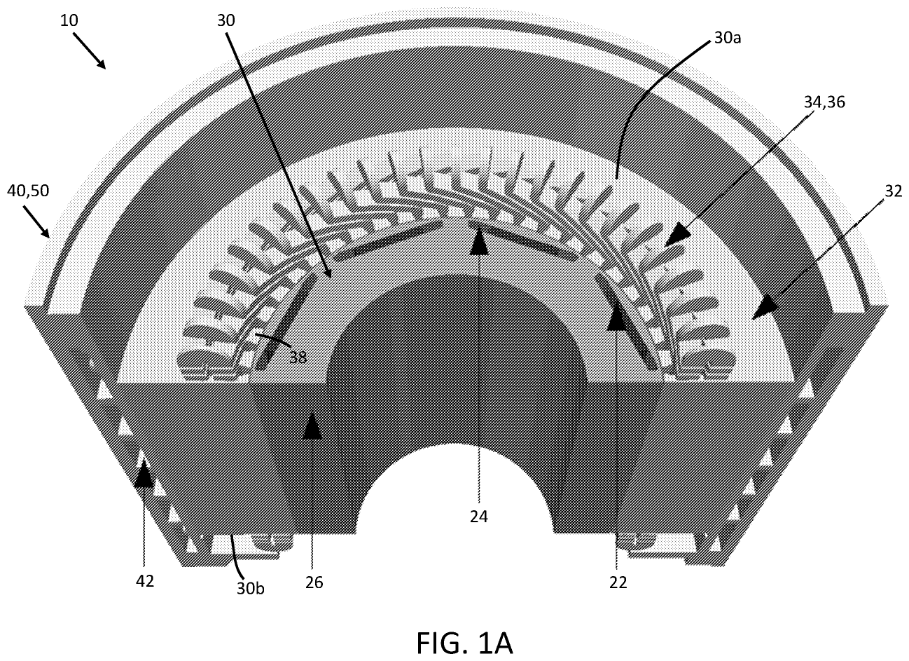

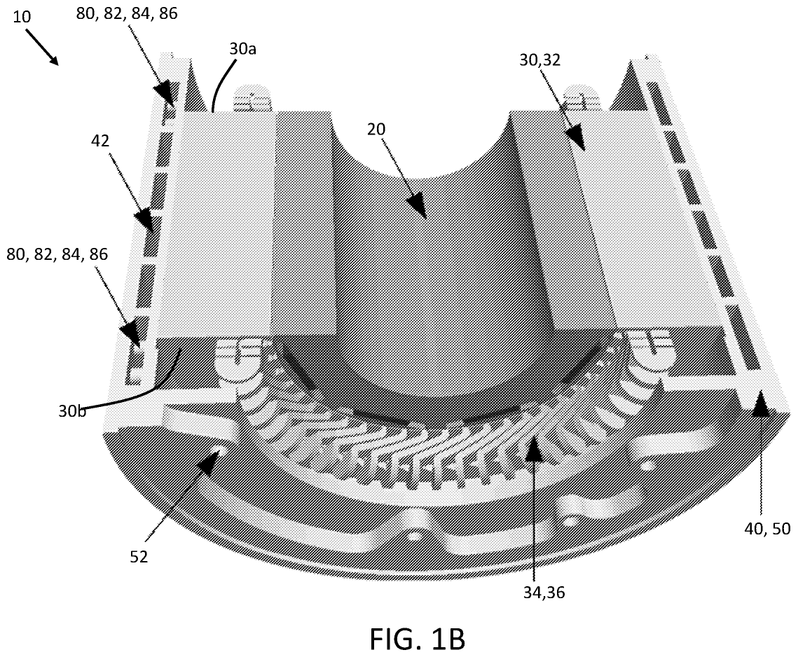

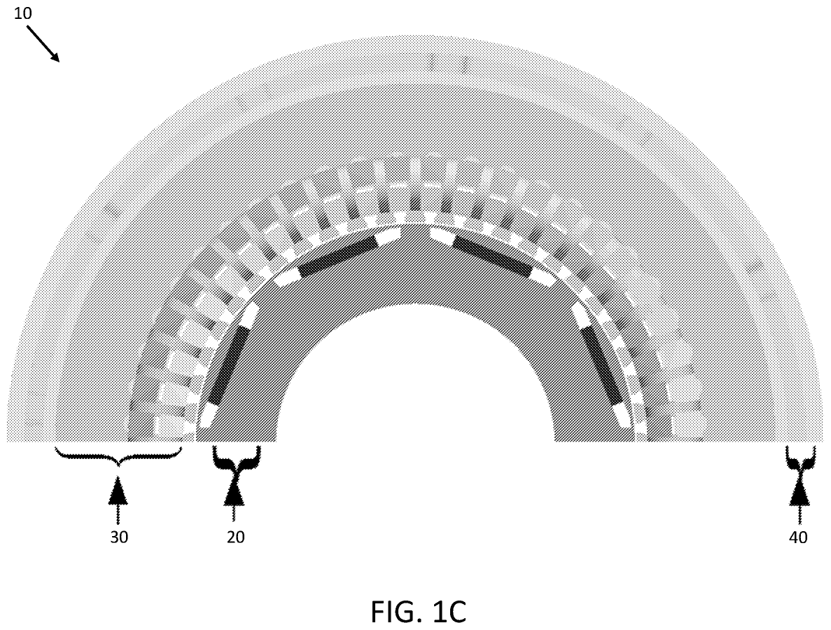

FIGS. 1A-1C show different cutaway views of the electric motor 10 in accordance with the present disclosure. The electric motor 10 may be, for example, a typical automotive AC electric motor. Specifically, FIGS. 1A-1C show the electric motor 10 including a rotor 20 configured to rotate about an axis, and a stator 30 disposed annularly around the rotor 20 and extending between a first axial end 30a and a second axial end 30b. This is merely an example, and the cooling jacket 40 of the present disclosure could be used in conjunction with other motor arrangements, such as a motor having an external rotor that is disposed outside of the stator 30. The electric motor 10 shown in the FIGS. is a permanent magnet synchronous motor (PMSM), with the rotor 20 including a plurality of permanent magnets 22 each disposed within a recess 24 of a rotor core 26. However, this is merely an example, and the cooling jacket 40 of the present disclosure may be used with other types of motors, including DC or AC motors such as wound-field motors, induction motors, etc.

The stator 30 includes a stator core 32, which may be made of metal laminations, and stator windings 34 extending through the stator core 32 in slots (not shown) between winding ends 36 at each of the axial ends 30a, 30b. More specifically, the stator core 32 defines a series of teeth 38 at regular circumferential intervals, with each of the teeth 38 extending radially inwardly and defining the slots for receiving the stator windings 34 between adjacent ones of the teeth 38. The cooling jacket 40 defines a fluid passage 42 disposed adjacent to the stator 30 and configured to convey a cooling fluid to remove heat from the stator 30. The winding ends 36 may generate significant heat that would necessitate the reduction of the thermal resistance between these components and the cooling jacket 40. Other regions such as stator core laminations, etc. typically have metallic contact with the cooling jacket 40.

The cooling jacket 40 has a first thermal conductance for transferring heat from the stator to the cooling fluid at a region between the first axial end 30a and the second axial end 30b. The cooling jacket 40 also has a second thermal conductance, greater than the first thermal conductance, at a region adjacent to one or both of the axial ends 30a, 30b of the stator 30. In other words, the cooling jacket 40 is configured to provide a greater heat transfer from one or both of the axial ends 30a, 30b than from the central region between the axial ends 30a, 30b. This greater heat transfer can improve cooling of the winding ends 36 which can otherwise have relatively high temperatures.

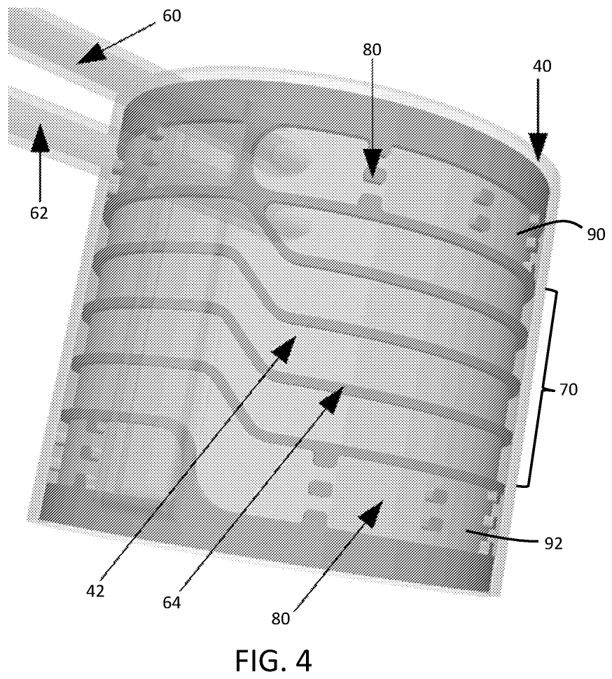

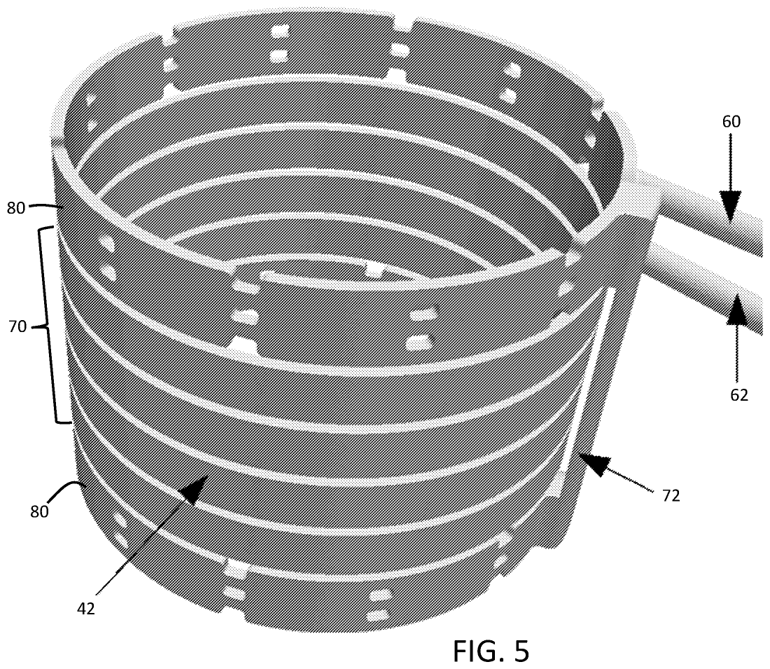

Depending on the geometry of the motor 10, the thermal conductance between the windings and the cooling jacket 40 can be increased by either sufficiently extending the thickness of the metallic jacket 40 unit radially inwards in the proximity of the windings 34 and filling the remaining void with electrically insulating thermally conductive material such as electronic potting epoxy (or other suitable material), or filling the entire region using such an epoxy. This would then result in greater heat flow to the regions of the jacket 40 that are closer to the winding ends 36, unlike conventional systems where most of the heat is transferred through the stator core laminations. Consequently, the overall thermal resistance between the electrical hardware in the motor and the cooling jacket 40 is reduced. The spatial distribution and reduction of average heat flux on the jacket wall through the increase in the overall heat transfer area is subsequently exploited to have cooling loops of reduced effective flow lengths in the jacket to reduce pressure drop or pump work, as shown in FIGS. 4-5.

In some embodiments, and as shown in FIGS. 1A-1C, the electric motor 10 includes a motor housing 50 that defines one or more mounting holes 52 or other structures for mounting the electric motor to a structure, such as a vehicle chassis. The motor housing 50 may be made of metal, such as aluminum or steel. However, the motor housing 50 may be made of other materials or a composite of different materials. In some embodiments, and as shown in FIGS. 1A-1C, the cooling jacket 40 is integrally formed with the motor housing 50. For example, the motor housing 50 defines the fluid passage 42 of the cooling jacket 40.

In some embodiments, the cooling jacket 40 has a thickness in a radial direction at the region adjacent to one or both of the axial ends 30a, 30b of the stator 30 which is greater than a thickness in the radial direction at the central region between the axial ends 30a, 30b. This greater thickness can provide greater heat transfer from one or both of the axial ends 30a, 30b than from the central region between the axial ends 30a, 30b.

In some embodiments, the cooling jacket 40 includes an electrically insulating material having a high thermal conductance located between the fluid passage 42 and a winding end 36 of the stator winding 34 adjacent one of the axial ends 30a, 30b of the stator 30. The electrically insulating material having a high thermal conductance may be, for example, an electronic potting epoxy.

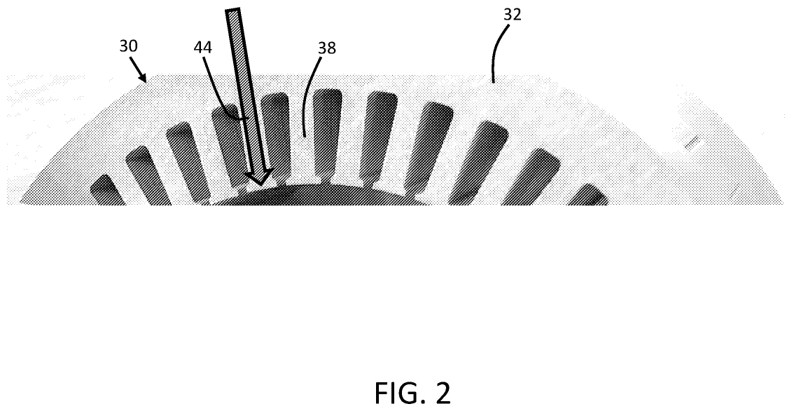

FIG. 2 shows a cross-sectional view of a stator 30 in accordance with some embodiments of the present disclosure. Specifically, FIG. 2 illustrates a stator core 32 that defines a plurality of teeth 38 circumferentially spaced apart from one another at regular intervals and each extending radially inwardly. Each of the teeth 38 defines a channel 44, such as a tube, extending therethrough in a radial direction for carrying a cooling fluid to remove heat therefrom. The cooling fluid may be automatic transmission fluid (ATF), although different cooling fluids may be used including gasses, liquids, or phase-changing refrigerant.

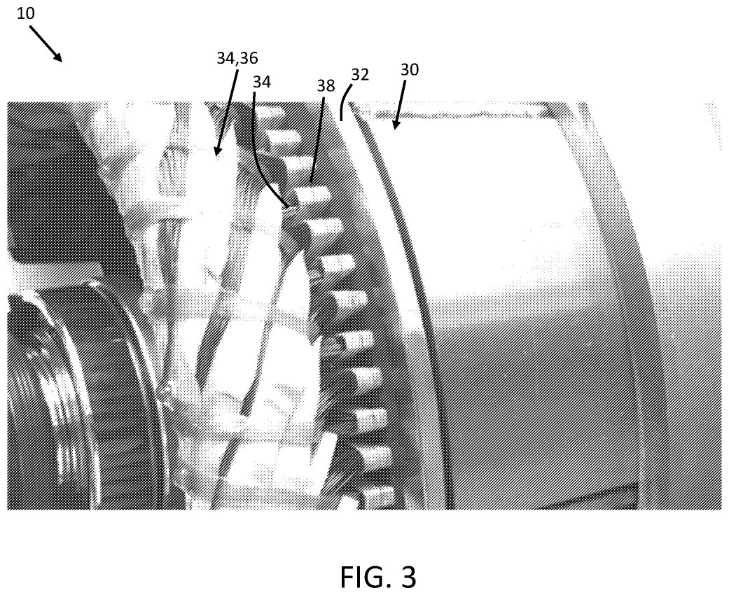

FIG. 3 shows an electric motor 10 including a stator 30, and showing the stator windings 34 passing between the teeth 38. FIG. 3 also shows available open space around the stator windings 34 and between the winding ends 36 and the stator core 32.

In some embodiments, the cooling jacket 40 includes the fluid passage 42 configured to convey the cooling fluid through the regions adjacent to each of the first axial end 30a and the second axial end 30b of the stator 30 before conveying the fluid through the region between the axial ends 30a, 30b. This is best shown with reference to FIGS. 4-5.

FIGS. 4-5 show a cooling jacket 40 for an electric motor in accordance with the present disclosure. Specifically, the cooling jacket 40 includes the fluid passage 42 configured to convey the cooling fluid from an inlet pipe 60 and to an outlet pipe 62. The inlet pipe 60 and the outlet pipe 62 are in fluid communication with one or more external devices, such as a pump and/or a heat exchanger or chiller to remove heat from the cooling fluid. The cooling jacket 40 includes walls 64 to define the fluid passage 42. The fluid passage 42 includes a first circumferential path 66 configured to surround a region adjacent to the first axial end 30a of the stator 30. The fluid passage 42 also includes a second circumferential path 68 configured to surround a region adjacent to the second axial end 30b of the stator 30. The fluid passage 42 also includes a central flow path 70 surrounding the central region between the axial ends of the stator 30. The central flow path 70 may have a stepped helical path, as shown in FIG. 4. The central flow path 70 may have other configurations such as, for example, a helical path with a continuous slope or a serpentine path.

As best shown in FIG. 5, the fluid passage 42 also includes a flow bridge 72 connecting the first circumferential path 66 to the second circumferential path 68. The flow bridge 72 provides for the cooling fluid to flow through each of the circumferential paths 66, 68 before flowing through the central flow path 72, thereby providing the coolest fluid to the circumferential paths 66, 68 and increasing heat transfer from the axial ends 30a, 30b.

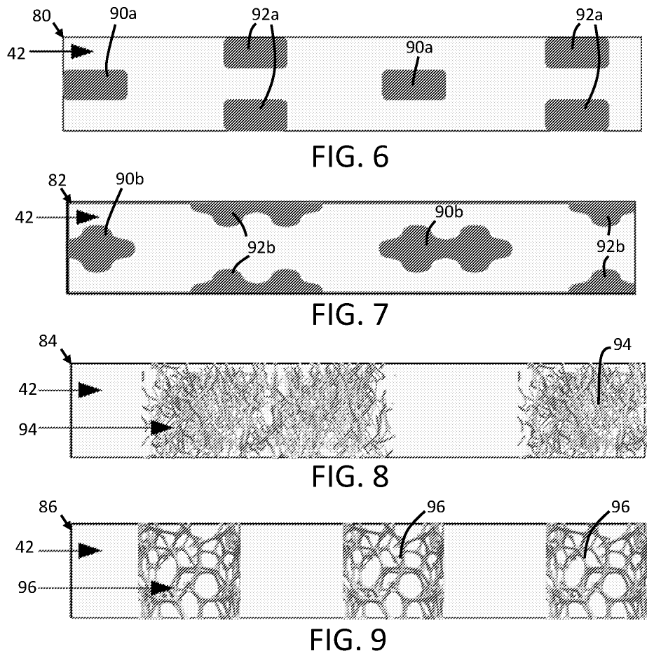

In some embodiments, and as shown in FIG. 4 and FIG. 5, one or both of the circumferential paths 66, 68 may include a flow mixing enhancer 80, 82, 84, 86 configured to increase the thermal conductance of the fluid passage 42. In some embodiments, and as shown in FIGS. 4A-4B, the flow mixing enhancer 80, 82, 84, 86 may be one of a first flow mixing enhancer 80 or a second flow mixing enhancer 82 having one or more baffles 90a, 90b, 92a, 92b configured to interrupt a laminar flow of the cooling fluid. More specifically, the baffles 90a, 90b, 92a, 92b may include one or more first baffles 90a, 90b configured to cause a flow of the cooling fluid to impinge upon one or more second baffles 92a, 92b. As shown in FIGS. 6-7, the first baffles 90a, 90b are spaced apart from the second baffles 92a, 92b in a flow direction, with adjacent ones of the first baffles 90a, 90b and the second baffles 92a, 92b offset from one another in a direction perpendicular to the flow direction. In some embodiments, and as shown in FIGS. 6-7, the baffles 90a, 90b, 92a, 92b a configured in a repeating pattern along the flow direction. For example, the baffles 90a, 90b, 92a, 92b may be arranged in an alternating pattern of first baffles 90a, 90b followed by second baffles 92a, 92b followed by another set of first baffles 90a, 90b. However, other arrangements may be used. For example, the flow mixing enhancer 80, 82, 84, 86 may include a third set of baffles that is offset from each of the first baffles 90a, 90b and second baffles 92a, 92b.

Increased heat transfer rates through the cooling jacket 40 close to the windings can be achieved using passive turbulence generators or flow mixing units 80, 82, 84, 86, as shown in FIGS. 6-9 integrated into the stator cooling jacket 40. Representative flow-mixing enhancers with rectangular baffles as shown in FIG. 6 which can be mounted using screws or cast into the jacket shown in FIGS. 4-5. In some embodiments, one or more of the flow mixing units 80, 82, 84, 86 may be located within the central flow path 70 and/or adjacent to one or both of the axial ends of the stator 30, which can provide enhanced cooling for heat generated by end windings 36, 136 of the stator 30 and/or the rotor 20.

Other mixing enhancement units 80, 82, 84, 86 can include (not limited to) curved shapes optimized for reduced pressure drop and mixing enhancement and porous inserts such as fibrous or open-cell foams. These units naturally act as heat spreaders and can be metallic, ceramic or other composite to also facilitate further heat transfer augmentation through increased surface area and thermal conductivity. In motors where the operating conditions are such that the conductivity of the mixing enhancement unit 80, 82, 84, 86 does not substantially affect the overall cooling performance, other non-metallic materials such as polymers or high temperature plastics can also be used for reduced weight and manufacturing costs.

The temperature of the coolant flowing in the cooling jacket 40 increases as it absorbs heat from the internals, and it is important to ensure that cooler fluid comes in contact with the section of the cooling jacket 40 closer to the winding ends 36. This is also important to ensure spatial temperature uniformity in the motor 10, which may otherwise result in an axial increase in the component temperatures in the direction parallel to the axis of the motor (or overall direction of coolant flow). This is accomplished by issuing the coolant through the inlet as shown in FIGS. 2-3 in the loop closer to one of the winding ends 36 (in this example, the rear windings) and subsequently transferring it to the jacket region closer to the other end winding through a bridge that bypasses the central flow pathways as shown in the FIGS. 4-5. Subsequently, the coolant flows through the central section absorbing heat that is lost through the stator laminations before leaving the cooling jacket 40 through the outlet pipe 62, as shown in the figure.

In some embodiments, and as shown in FIG. 6, one or more of the baffles 90a, 90b, 92a, 92b has a rectangular cross-section. In some embodiments, and as shown in FIG. 7, one or more of the baffles 90a, 90b, 92a, 92b has an irregular surface. Such an irregular surface may be configured to generate turbulence in the cooling fluid and to increase thermal conductance between the fluid passage and the cooling fluid therein. In some embodiments, and as shown in FIG. 8, the flow mixing enhancer 80, 82, 84, 86 includes a porous fibrous structure 94. In some embodiments, and as shown in FIG. 9, the flow mixing enhancer 80, 82, 84, 86 includes an open-cell foam structure 96. In some embodiments, the flow mixing enhancer 80, 82, 84, 86 may include a combination of one or baffles 90a, 90b, 92a, 92b together with a porous fibrous structure 94 and/or an open-cell foam structure 96. One or more parts of the flow mixing enhancer 80, 82, 84, 86 may be made of metal, ceramic, and/or composite material to conduct heat between the fluid passage and the cooling fluid therein.

In some embodiments, the cooling jacket 40 provides increased thermal conductance to one or both of the axial ends 30a, 30b of the stator 30 by discharging the cooling fluid from one or more nozzles 104, 106 at or near the axial ends 30a, 30b.

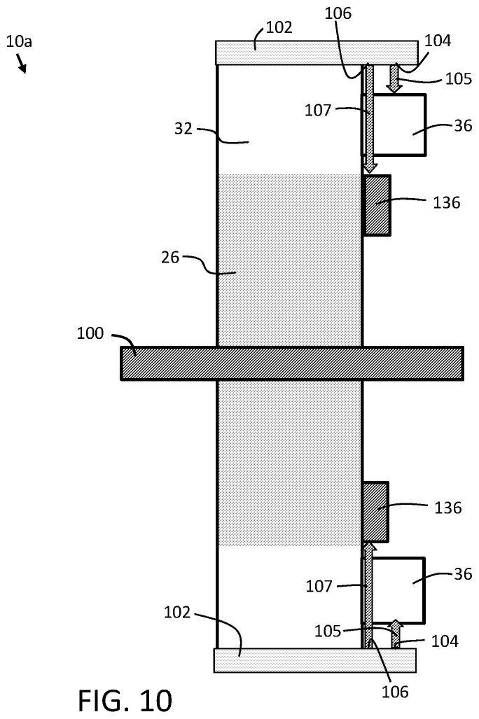

FIGS. 10-12 show electric motors 10a, 10b, 10c with the three different types of cooling systems. FIG. 10 shows a cross-sectional view of an electric motor 10a having a first configuration in accordance with an aspect the present disclosure. Specifically, the electric motor 10a includes a rotor core 26 coupled to a shaft 100, with the rotor core 26 surrounded by a stator core 32. A stator jacket 102 surrounds the stator core 32 for carrying a cooling fluid. The stator jacket 102 may be formed of metal, although other materials may be used to form all or part of the stator jacket 102. The stator jacket 102 extends axially beyond the stator core 32 and defines one or more first nozzles 104 each configured to spray a first jet 105 of cooling fluid out of the stator jacket 102 to impinge upon a stator end winding 36. The stator jacket 102 may be liquid cooled and may also function to remove heat from the stator core 32. The stator jacket 32 may be about the same size as the stator core 32. The first nozzles 104 may include and an array of first nozzles 104 placed circumferentially around the shaft 100.

FIG. 10 also shows a second nozzle 106 configured to spray a second jet 107 of cooling fluid out of the stator jacket 102 to impinge upon a rotor end winding 136. One or more of the second jets 107 may extend through a channel 44 within a corresponding one of the stator teeth 38 (see, for example, FIG. 2). Alternatively or additionally, one or more of the second jets 107 may extend adjacent to a corresponding one of the stator teeth 38 and thus between corresponding ones of the stator windings 34. FIG. 10 shows two of each of the nozzles 104, 106. However, there may be any number of nozzles 104, 106 disposed circumferentially around the stator core 32. At least some of the nozzles 104, 106 may be in fluid communication with the cooling jacket 102 for supplying the cooling fluid thereto. In some embodiments, the jets 105, 107 may include a liquid coolant. Alternatively or additionally, the jets 105, 107 may include a gas and/or a fluid such as a refrigerant that is configured to change from a liquid or a solid to a gas and to thereby remove heat from the corresponding one of the end windings 36, 136. In some embodiments, the first nozzle 106 is configured to spray the first jet 105 through gaps between teeth of the stator core 32. The cooling fluid may drain after removing heat from components in the motor 10a, and drain through gravity to a sump from where it is pumped back after heat removal in an appropriate heat exchanger. The cooling fluid used by the stator jacket 102 for cooling the stator 30 can be the same or different from that used for direct cooling of the stator and rotor windings. If the same fluid is used both in the jacket and for direct cooling of the windings, the cooling fluid may be a suitable dielectric liquid such as (but not limited to) transmission oil. Alternatively, if two separate fluids are used in the jacket, the one used in the direct cooling would still be a suitable dielectric liquid such as (but not limited to) transmission oil, while the coolant in the stator jacket can also include other fluids including water or mixtures of water and glycol. In cases where two separate fluids are used, separate fluid inlets to the stator jacket 102 may be provided to provide the coolant supply to the nozzles 104, 106.

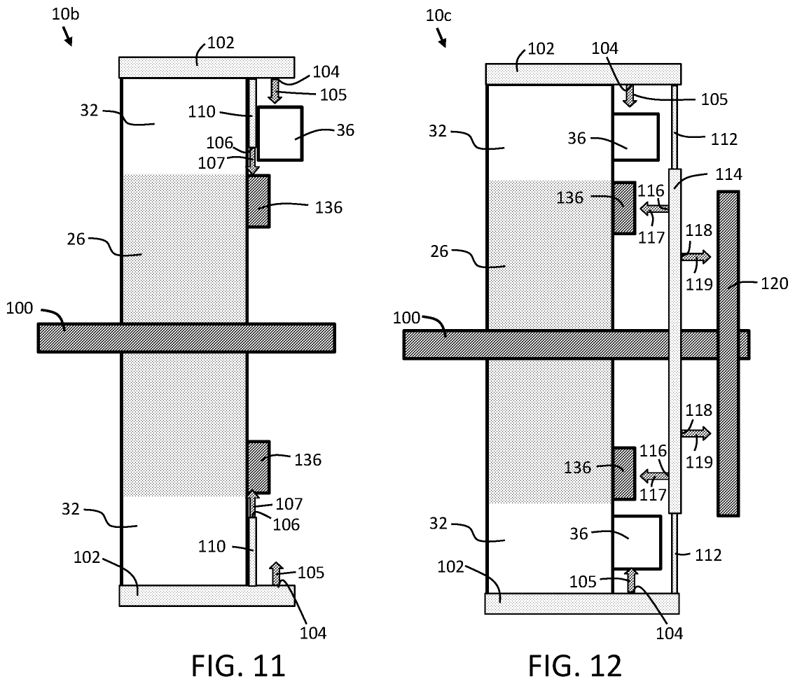

FIG. 11 shows a cross-sectional view of an electric motor 10b having a second configuration in accordance with an aspect the present disclosure. The electric motor 10b of FIG. 11 is similar to the electric motor 10a of FIG. 10, but with the addition of one or more first radial pipes 110 defining the second nozzle 106 on an end thereof and at a position radially inwardly from the stator jacket 102. In other words, the first radial pipes 110 are configured to convey the cooling fluid from the stator jacket 102 before the cooling fluid is discharged toward the rotor end winding 136 as the second jet 107. The first radial pipes 110 may be located axially between the stator core 32 and the winding ends 36, as shown in FIG. 11. However, the first radial pipes 110 may have a different arrangement. For example, one or more of the first radial pipes 110 may extend through the winding ends 36 and/or within the stator core 32. One or more of the first radial pipes 110 may extend through a channel 44 within a corresponding one of the stator teeth 38 (see, for example, FIG. 2). Alternatively or additionally, one or more of the first radial pipes 110 may extend adjacent to a corresponding one of the stator teeth 38 and thus between corresponding ones of the stator windings 34. These first radial pipes 110 enable more optimized supply of the coolant to the rotor sections with precisely definable flow rates and velocity profiles as necessary for the heat generation characteristics of the motor.

In some embodiments, the first radial pipes 110 may have an elongated or a flat cross-section. In some embodiments, the first radial pipes 110 may have a rectangular, round or other cross-sectional shape. In some embodiments, the first radial pipes 110 may be disposed adjacent to a corresponding one of the stator teeth 38. In some embodiments, one or more of the first radial pipes 110 may take the form of a channel 44 within a corresponding one of the stator teeth 38. FIG. 11 shows two of each of the nozzles 104, 106. However, there may be any number of nozzles 104, 106 disposed circumferentially around the stator core 32. At least some of the nozzles 104, 106 may be in fluid communication with the cooling jacket 102 for supplying the cooling fluid thereto. In some embodiments, the jets 105, 107 may include a liquid coolant. Alternatively or additionally, the jets 105, 107 may include a gas and/or a fluid such as a refrigerant that is configured to change from a liquid or a solid to a gas and to thereby remove heat from the corresponding one of the end windings 36, 136. In some embodiments, the first nozzle 106 is configured to spray the first jet 105 through gaps between teeth of the stator core 32. FIG. 11 shows two of the first radial pipes 110. However, there may be any number of first radial pipes 110 disposed circumferentially around the stator core 32.

FIG. 12 shows a cross-sectional view of an electric motor 10c having a third configuration in accordance with an aspect the present disclosure. The electric motor 10c of FIG. 12 is similar to the electric motor 10a of FIG. 10, but with the addition of a second radial pipe 112 conveying the cooling fluid from the stator jacket 102 to a coolant header 114 that defines one or more third nozzles 116 configured to spray corresponding third jets 117 in an axial direction toward the rotor 26. For example, and as shown in FIG. 12, the third jets 117 may be configured to impinge upon the rotor end windings 136 of the rotor 26. In some embodiments, the coolant header 114 may have a ring shape surrounding the shaft 100 and coaxially therewith. In some embodiments, and as shown in FIG. 12, the second radial pipes 112 may be disposed outside of the stator end windings 36, with the stator end windings 36 between the stator core 32 and the second radial pipes 112. Alternatively, one or more of the second radial pipes 112 may extend through the stator end windings 36.

In some embodiments, and as shown on FIG. 12, the coolant header 114 may define one or more fourth nozzles 118 each configured to direct a corresponding fourth jet 119 away from the rotor 26. For example, and as shown in FIG. 12, each of the fourth jets 119 may be directed axially (i.e. parallel to the axis of rotation of the shaft 100) toward a rotating printed circuit board (PCB) 120 that is coupled to rotate with the shaft 100. Such printed circuit boards 120 are commonly used to hold sensor devices or power electronics such as drivers providing excitation power to the rotor 20. These electronic devices may generate substantial heat that will have to be effectively and efficiently removed for safe and optimal operation of the electric motor and these controlling electronics.

FIG. 12 shows two of each of the nozzles 104, 116, 118. However, there may be any number of nozzles 104, 116, 118. At least some of the nozzles 104, 116, 118 may be in fluid communication with the cooling jacket 102 for supplying the cooling fluid thereto. In some embodiments, the jets 105, 117, 119 may include a liquid coolant. Alternatively or additionally, the jets 105, 117, 119 may include a gas and/or a fluid such as a refrigerant that is configured to change from a liquid or a solid to a gas and to thereby remove heat from the corresponding one of the end windings 36, 136 and/or the rotating PCB 120. FIG. 12 shows two of the second radial pipes 112. However, there may be any number of second radial pipes 112 disposed circumferentially around the stator core 32. These nozzles 104, 116, 118 may be angled both towards the rotor windings as well as towards the heat generating electronic components on the PCB 120.

Similar to the first and second motor configurations 10a, 10b, the cooling fluid in the third motor configuration 10c may drain to a sump from where it is pumped back through a heat exchanger. The liquid used in the stator jacket 102 can the same or different from that used for direct cooling of the stator and rotor windings 36, 136. If the same fluid is used both in the jacket 102 and for direct cooling of the windings 36, 136, the fluid may be a suitable dielectric liquid such as (but not limited to) transmission oil. Alternatively, if two separate fluids are used in the jacket 102, the one used in the direct cooling would still be a suitable dielectric liquid such as (but not limited to) transmission oil, while the coolant in the stator jacket 102 can also include other fluids including water or mixtures of water and glycol. In this latter case, separate fluid inlets to the metallic jacket section that houses the supply lines to the stator/rotor windings 36, 136 and the PCB 120 may be required for coolant supply.

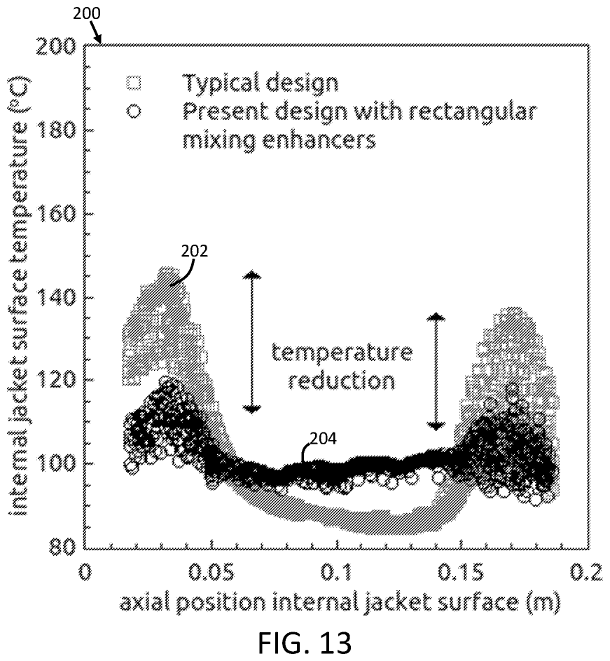

FIG. 13 shows a graph 200 including a first plot 202 of internal jacket temperatures for a conventional cooling jacket and a second plot 204 of internal jacket temperatures for a cooling jacket 40 in accordance with the present disclosure. More specifically, the second plot 204 shows temperature distributions on the internal surface of the cooling jacket 40 obtained from a conjugate computational fluid dynamics and heat transfer simulations carried out using a representative configuration illustrated in FIGS. 1A-1C and 4-5, including the first flow mixing enhancer 80 with rectangular-shaped baffles 90a, 92a. Each of the plots 202, 204 show relatively higher temperatures at axial positions between 0.01 and 0.05 m, corresponding to the first axial end 30a of the stator 30. Each of the plots 202, 204 also show relatively higher temperatures at axial positions between 0.15 and 0.19 m, corresponding to the second axial end 30b of the stator 30. However, the internal jacket temperatures of the cooling jacket 40 of the present disclosure and shown on the second plot 204 are more consistent along the entire length of the stator of the stator 30. Also, the cooling jacket 40 of the present disclosure has much lower temperatures at the axial ends 30a, 30b of the stator 30. The first plot 202 shows highest internal jacket temperatures at the axial ends 30a, 30b of the conventional cooling jacket of about 149 degrees C., and 139 degrees C., respectively. The second plot 204 shows highest internal jacket temperatures of about 120 degrees C. at each of the axial ends 30a, 30b of the cooling jacket 40 of the present disclosure.

The foregoing description is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. An electric motor, comprising:
a stator having a stator core and extending between a first axial end and a second axial end;
a cooling jacket disposed circumferentially around the stator core and configured to convey a cooling fluid therethrough;
wherein the cooling jacket has a first thermal conductance for transferring heat from the stator to the cooling fluid at a region between the first axial end and the second axial end; and
wherein the cooling jacket has a second thermal conductance at a region adjacent to at least one of the first axial end or the second axial end of the stator, the second thermal conductance being greater than the first thermal conductance.

2. The electric motor of claim 1, wherein the cooling jacket is configured to convey the cooling fluid through the regions adjacent to each of the first axial end and the second axial end of the stator before conveying the cooling fluid through the region between the first axial end and the second axial end.

3. The electric motor of claim 1, wherein the cooling jacket has a thickness in a radial direction at the region adjacent to the at least one of the first axial end or the second axial end of the stator which is greater than a thickness in the radial direction at the region between the first axial end and the second axial end.

4. The electric motor of claim 1, further comprising an electronic potting epoxy being an electrical insulator and having a high thermal conductance and located between the fluid passage and a winding end of the stator winding located adjacent the at least one of the first axial end or the second axial end of the stator.

5. The electric motor of claim 1, further comprising a flow mixing enhancer disposed within the fluid passage adjacent the at least one of the first axial end or the second axial end of the stator and configured to increase a thermal conductance of the fluid passage.

6. The electric motor of claim 5, wherein the flow mixing enhancer includes a first baffle configured to cause a flow of the cooling fluid to impinge upon a second baffle.

7. The electric motor of claim 6, wherein the first baffle and the second baffle are spaced apart from one another in a flow direction and offset from one another in a direction perpendicular to the flow direction.

8. The electric motor of claim 5, wherein the flow mixing enhancer includes a plurality of first baffles and a plurality of second baffles in a repeating pattern along a flow direction of the cooling fluid, with each of the first baffles being configured to cause a flow of the cooling fluid to impinge upon a corresponding one of the second baffles.

9. The electric motor of claim 5, wherein the flow mixing enhancer includes at least one baffle having an irregular surface configured to generate turbulence in the cooling fluid and to increase thermal conductance between the fluid passage and the cooling fluid therein.

10. The electric motor of claim 5, wherein the flow mixing enhancer includes one of a porous fibrous structure or an open-cell foam structure.

11. The electric motor of claim 1, further comprising:
the stator including a stator end winding at one of the first axial end or the second axial end thereof; and
a nozzle in fluid communication with the cooling jacket and configured to direct a jet of the cooling fluid to impinge upon the stator end winding.

12. The electric motor of claim 1, further comprising:
a rotor configured to rotate relative to the stator and having a rotor end winding adjacent to one the first axial end or the second axial end; and
a nozzle in fluid communication with the cooling jacket and configured to direct a jet of the cooling fluid to impinge upon the rotor end winding.

13. The electric motor of claim 12, further comprising:
a radial pipe in fluid communication with the cooling jacket and extending radially inwardly therefrom; and
wherein the nozzle is disposed on an end of the radial pipe at a position radially inwardly from the cooling jacket.

14. The electric motor of claim 12, further comprising:
a coolant header in fluid communication with the cooling jacket and disposed radially inwardly therefrom; and
wherein the coolant header defines the nozzle to direct the jet of the cooling fluid in an axial direction and upon the rotor end winding.

15. The electric motor of claim 12, further comprising:
a rotating printed circuit board coupled to rotate with a shaft of the electric motor; and
a coolant header in fluid communication with the cooling jacket and disposed axially between the stator and the rotating printed circuit board, the coolant header including at least one nozzle configured to direct a jet of the cooling fluid to impinge upon the rotating printed circuit board or an electronic component disposed thereupon.

16. The electric motor of claim 1, wherein the region adjacent to the at least one of the first axial end or the second axial end of the stator and having the second thermal conductance includes regions adjacent to both of the first axial end and the second axial end of the stator.

17. The electric motor of claim 5, wherein the flow mixing enhancer includes at least one baffle having a rectangular cross-section.

18. The electric motor of claim 5, wherein the flow mixing enhancer includes at least one of a metal, a ceramic, or a composite material to conduct heat between the fluid passage and the cooling fluid therein.

19. The electric motor of claim 10, wherein the flow mixing enhancer includes the porous fibrous structure.

20. The electric motor of claim 14, wherein the coolant header has a ring shape surrounding a shaft of the motor and extending coaxially therewith.
